(19) United States
(12) Patent Application Publication
(10) Pub. No.: US 2003/0111017 A1
(43) Pub. Date: Jun. 19, 2003

(54) Mechanical milking procedure for animals, especially cows

(76) Inventor: Bernhard Schulze Wartenhorst, Warendorf (DE)

Correspondence Address: SMITH MOORE LLP, P.O. BOX 21927, GREENSBORO, NC, 27420, US

(21) Appl. No.: 10/015,740

(22) Filed: Dec. 13, 2001

(51) Int. Cl. A01J 3/00; A01J 5/00

(52) U.S. Cl. 119/14.02

(57) ABSTRACT

The present invention pertains to a mechanical milking procedure for animals, especially cows. In particular, the present invention is a method for milking animals that includes the step of sequentially stimulating the teats of the animal before milking the stimulated teats. This method results in a quick and uninterrupted milking of the animal.

### TECHNICAL FIELD

The subject of this invention is in regard to a mechanical milking procedure for animals, especially cows.

### BACKGROUND OF THE INVENTION

It is known that, the milking behavior of an animal, especially a cow, increases by stimulating the udder before the milking process. The oldest method to stimulate the udder is manual udder massage that, for example, could take place by hand during the cleaning of the udder. The cleaning of the udder is the first tactical stimulus for the stimulation of the animal. Afterwards, the stimulation continues during the actual milking procedure, which takes place after the udder stimulation.

Different mechanical milking procedures of animals, especially cows, are known through DE 33 23 676 C2, which also include udder stimulation.

During further development of milking devices, they became known as described, for example, in the EP 0 300-115 B1. With these milking devices, each milking cup is attached to a teat. A sensor locates the position of the teat and, by means of an attachment device, compares the position and changes the position of the milking cup on the teat until the attachment device pushes the teat cup over the teat. The time span necessary to push every teat cup over the teat might vary due to the fact that locating every teat also depends on the actual position of the teat within the milking location. In a milking location in which the animal is free to move the time frame might increase even more.

There is the possibility of forcing the animal into a milking position, but this would upset the animal, which decreases the milking behavior.

Therefore, a higher time frame might occur during the first stimulation and the actual milking procedure. That means that the stimulation intensity as well as the availability and effectiveness of the Ocytocin hormone is influenced which results in a decreased milk output of the animal. In such a case, it is possible that a waiting period occurs during the stimulation and the actual milking process and therefore the stimulation by itself is not sufficient to guarantee a complete and uninterrupted milking.

### SUMMARY AND OBJECTS OF THE INVENTION

Therefore the function of the following invention is to design a procedure, which increases the milking behavior of the animal especially when a waiting period occurs during the pre-stimulation and the actual milking process.

This task has been solved with a mechanical milking procedure of animals, especially cows during which to stimulate the udder the teats of the animal are sequentially stimulated. Beneficial, aspects of the invention are the subject matter of the claims.

### DETAILED DESCRIPTION OF THE INVENTION

In accordance with the invented mechanical milking procedure for animals, especially cows, it is suggested for the teat stimulation to stimulate the teats of the animals sequentially. Here, the stimulation does not occur for all teats at the same time, but of selected single or multiple teats. The remaining teats are not stimulated which means that here the natural milk flow intensity of the animal can be used during the milking of the animal. By means of this procedure, a quick and uninterrupted milking of the animal occurs. This results in a time decrease of the milking process.

Therefore the number of milked cows per hour in mechanical milking units can be increased which is an important business aspect.

By means of the invented procedure, it is also possible to proceed with the milking procedure within a certain time frame in which the Ocytocin hormone still has an impact on the contraction of the alveolar tissue of the teat.

Surprisingly, it has been noted that the invented procedure is very effective when only single teats are being stimulated successively. Therefore, the stimulation of specific teats can occur periodically. During the stimulation of one teat other teats are being milked which means a further time decrease of the milking process.

A further favorable arrangement of the procedure suggests proceeding with a phase without stimulation between two stimulation phases of two different teats without increasing the time frame of the milking process. The stimulation can also occur continuously which means, immediately after the stimulation phase of one teat the stimulation of another teat occurs.

Another favorable arrangement of the procedure suggests the stimulation of the udder before the sequential stimulation of single teats. The pre-stimulation can, for example, occur during the cleaning of the udder of the animal. Also a period without any stimulation can occur between the pre-stimulation and the sequential stimulation afterwards, during which, for example, milking cups are being attached to the teats of the animal.

The phase without stimulation which might have a negative influence on the milking results during regular mechanical milking procedures is being compensated by means of the procedure of the sequential stimulation of single teats of the udder. The animal will experience a positive anticipation even if waiting periods occur.

The stimulating effect can be achieved by means of pulsate pressure procedures in the milking cup gaps. Here the intensity of the sequential stimulation during the milking procedure can be changed. It is especially suggested to decrease the intensity of the sequential stimulation during the milking process to guarantee a fast and uninterrupted milking after another stimulation occurs.

The decrease of the intensity of the sequential stimulation can occur continuously. It is also possible to decrease the intensity of the sequential stimulation during the milking procedure discontinuously.

Preferably, the intensity of the sequential stimulation occurs during one of the first periods of the milking procedure of the animal. It is especially suggested to decrease the intensity of the stimulation after about 2 minutes in to milking period and to end the stimulation at the end of the milking period.

Another favorable arrangement of the procedure suggests to measure or determine the milk flow or appropriate reference number during the milking process and to change the intensity of the sequential stimulation in accordance to the milk flow or the reference number. By measuring the milk flow, it is possible to determine the end of the milk period due to the decreasing milk flow so that the change of the milk flow can be used as a starting reference point for the determination of the intensity period of the sequential stimulation. It is also possible, by recording the total amount of milk, to differentiate a reference number of the pre-milking periods. Preferably the reaching of 50 to 75% of the usual amount of milk decreases the intensity of the stimulation.

Due to the fact that the animals to be milked appear periodically at the milking location, the registration of special data, for example the milking period of a previous milking process, can determine the actual milking periods.

The intensity of the stimulation can also be adjusted to individual animals. It is especially suggested to decrease the stimulation reaching the middle of the milking period if the animal is at the beginning of lactation. During the proceeding lactation, a flexible increase of the stimulation can be adjusted at the beginning until the middle of the milking procedure, which then decreases.

What is claimed is:

1. A method for milking animals, especially cows, said method comprising the step of:
a) sequentially stimulating the teats of the animal as a way to stimulate the udder; and
b) milking the stimulated teats.

2. The method of claim 1, during which only single teats are being stimulated successively.

3. The method of claim 2, during which a phase without any stimulation occurs during 2 stimulation phases.

4. The method of claim 2, during which, at the end of a stimulation phase of a teat a stimulation phase of another teat occurs.

5. The method of claim 1 during which, before the sequential stimulation of a single teat, the udder receives a pre-stimulation.

6. The method of claim 5, during which the intensity of the sequential stimulation decreases during the milking procedure.

7. The method of claim 6, during which the intensity of the sequential stimulation during the milking procedure decreases continuously.

8. The method of claim 6, during which the intensity of the sequential stimulation during the milking procedure decreases discontinuously.

9. The method of claim 5 during which the milk flow or a relevant reference number is either measured or determined during the milking procedure, and to change the intensity of the sequential stimulation in accordance to the milk flow or the relevant reference number.
